(19) United States
(12) Patent Application Publication
(10) Pub. No.: US 2014/0295706 A1
(43) Pub. Date: Oct. 2, 2014

(54) PLUG CONNECTOR WITH SHIELDING

(71) Applicant: ERNI Production GmbH & Co. KG, Adelberg (DE)

(72) Inventor: Juergen Lappoehn, Gammelshausen (DE)

(73) Assignee: ERNI Production GmbH & Co. KG, Adelberg (DE)

(21) Appl. No.: 14/360,408

(22) PCT Filed: Nov. 22, 2012
(86) PCT No.: PCT/DE2012/001111

§ 371 Date: May 23, 2014

(30) Foreign Application Priority Data
Nov. 24, 2011 (DE) 10 2011 119 274.7

(51) Int. Cl. H01R 13/6581

(52) U.S. Cl. CPC H01R 13/6581
USPC 439/607.34

(57) ABSTRACT

A plug connector featuring shielding of the signal contacts that are arranged in a contact pattern of differential pairs and that form a contact group together with a shielding element surrounding same. The contact groups are arranged in rows and columns. Each shielding contact includes a shielding element and at least one shielding contact element. Each signal contact includes a blade element and a signal contact element. All shielding contact elements within a row are aligned in a straight line. Each of the signal contact elements of each differential pair are aligned in a straight line that forms a 45° angle with the straight line of the shielding contact elements within the row. An arrangement can be made from two such plug connectors and a circuit board, wherein the two plug connectors are rotated 90° relative to each other.

The present invention relates to a plug connector with shielding, comprising signal contacts. The invention further relates to an electronic arrangement which comprises two plug connectors in accordance with the invention which are arranged on two opposite sides of a circuit board.

### DESCRIPTION OF THE PRIOR ART

Plug connectors with shielding are known for example from EP 1 470 618 B1. Plug-and-socket connections are frequently used in the electronic industry for an electrical connection between two circuit boards, e.g. a so-called backplane and circuit boards fixed thereto, or also between circuit boards and connecting lines. A male multipoint connector is arranged for example on a first circuit board and a female multipoint collector adapted thereto on a further circuit board. Said further circuit board is then fixed by means of the female multipoint connector to the first circuit board and the electrical contact is established.

The transmission frequency of electrical signals transmitted via said plug connectors can be very high. This not only requires a balanced impedance of the various contacts within the multipoint plug in order to reduce signal delays and reflections, but also a shielding of the differential contacts. This is realised by an L-shaped shielding as is disclosed in EP 1 470 618 B1.

In order to achieve optimal data transmission rates, EP 1 470 618 B1 provides a pin contact strip with signal contacts which are arranged in a contact pattern of differential pairs which are aligned in rows and columns, wherein each differential pair comprises two of the signal contacts which are spaced from each other by a first distance. Ground shielding is connected to each differential pair, wherein each ground shielding comprises a blade section which extends along one side of the two signal contacts in its associated pair, and wherein each ground shielding comprises a leg section which extends along an end of an associated differential pair, and wherein adjacent ones of the differential pairs are spaced by a second distance which is greater than the first distance.

A plug connector is known from DE 10 2009 010 487 A1 which enables high data transmission rates. It further offers the advantage that it does not have the filigree configuration of the plug connector as described above, which in many cases does not offer the required stability in order to enable easy multiple plugging and releasing of the two plug connection elements, i.e. the male multipoint connector and female multipoint connector.

The arrangement of the differential pairs in the known plug connectors leads to the consequence however that two plug connectors which are to be arranged on different sides of a circuit board and whose respectively corresponding contact elements are simultaneously connected to each other in an electrically conductive manner can only be fixed to the circuit board in such a way that the second plug connector is arranged in a mirror-inverted manner in relation to the first plug connector, or it is twisted in relation to said first plug connector by 180°. If circuit boards are to be arranged twisted by 90° on two sides of a backplane with respect to each other, it is desirable to enable the arrangement of two plug connectors on different sides of the backplane twisted by 90° with respect to each other. The invention is therefore based on the object of further developing a generic plug connector with shielding in the respect that such plug connectors can be arranged twisted by 90° with respect to each other on two opposite sides of a circuit board, wherein respective contact elements should establish contact to each other as directly as possible.

### SUMMARY OF THE INVENTION

This object is achieved by the plug connector in accordance with the invention with shielding of the signal contacts which are arranged in a contact pattern of differential pairs and form a contact group together with a shielding element surrounding the same. The contact groups are arranged in rows and columns. Each shielding contact comprises a shielding element and at least one shielding contact element. Each signal contact comprises a blade element and a signal contact element. All shielding contact elements within a row are aligned in a straight line. The signal contact elements of each differential pair are respectively aligned in a straight line that forms an angle of 45° with the common straight line of the shielding contact elements within the row.

In particular, all shielding contact elements within a column also lie on a common straight line and the signal contact elements of each differential pair respectively lie on a straight line which forms an angle of 45° with the common straight line of the shielding contact elements within the column. Furthermore, all blade elements in particular are situated within a column on a common straight line.

In each row and in each column, a distance between the centre point of the two signal contact elements of a differential pair and the centre point of the signal contact elements of an adjacent differential pair preferably substantially correspond to the distance between two adjacent shielding contact elements. The centre point shall be understood in accordance with the invention as being the point which is situated on a connecting straight line between the two signal contact elements of a differential pair halfway between these two signal contact elements. Adjacent shall be understood as two differential pairs or shielding contact elements which directly follow each other within a row or within a column.

In order to realise the most compact shielding of the differential pairs, the shielding elements are preferably arranged in an L-shaped way. Since the respective last differential pair of a row or a column is not shielded towards the edge of the plug connector, it is further preferable in accordance with the invention that a shielding element is arranged in a C-shaped way in each column. If said C-shaped shielding element is arranged at the end of the column, the additional leg of the C ensures shielding of the last differential pair towards the edge of the plug connector in comparison to the L. Each shielding contact with an L-shaped shielding element preferably comprises only one shielding contact element in order to enable the arrangement of shielding contact elements and signal contact elements in accordance with the invention. Each shielding contact element with C-shaped shielding element preferably comprises two shielding contact elements in order to ensure secure fixing of the C-shaped shielding element to the plug connector.

The arrangement of blade elements and signal contact elements in accordance with the invention can now be realised in accordance with the invention by a special configuration of the signal elements. It is preferable in this respect that the blade element and the signal contact element of each signal element are arranged in parallel with respect to each other and are connected to each other by a connecting element. In particular, the connecting element is substantially arranged in a rod-shaped way and forms an angle of 90° both with the blade element and also with the signal contact element.

The distance between the two signal contact elements of each differential pair preferably corresponds in accordance with the invention substantially to the distance between the two blade elements.

The plug connectors in accordance with the invention can be used for realising an arrangement which respectively comprises two plug connectors and one circuit board. The signal contact elements and shielding contact elements of the first connector are arranged on one side of the circuit board and the signal contact elements and shielding contact elements of the second connector are arranged on the other side of the circuit board. In this respect, the signal contact elements of the first plug connector are connected to the signal contact elements of the second plug connector and the first plug connector is twisted at an angle of 90° in relation to the second plug connector. Since the circuit board acts as a backplane, this arrangement of two plug connectors in accordance with the invention allows the connection of two further circuit boards, which are arranged on the two opposite sides of the backplane, at an angle of 90° with respect to each other via the backplane.

### BRIEF DESCRIPTION OF THE DRAWINGS

An embodiment of the invention is shown in the drawings and will be explained in the description below in closer detail, wherein:

FIG. 1 shows a top view of a rear side of a plug connector according to the state of the art;

FIG. 2 shows a top view of a front side of a plug connector according to the state of the art;

FIG. 3 shows a detailed sectional view of FIG. 2;

FIG. 4 shows an isometric view of a differential pair of a plug connector according to the state of the art;

FIG. 5 shows a bottom view of a differential pair of a plug connector according to the state of the art;

FIG. 6 shows a top view of a rear side of a plug connector according to an embodiment of the invention;

FIG. 7 shows a top view of a front side of the plug connector according to an embodiment of the invention;

FIG. 8 shows a detailed sectional view of FIG. 7;

FIG. 9 shows an isometric view of a differential pair of a plug connector according to an embodiment of the invention;

FIG. 10 shows a view from below of a differential pair of a plug connector according to an embodiment of the invention;

FIG. 11 shows an isometric view of the arrangement of two plug connectors twisted by 90° with respect to each other according to an embodiment of the invention;

FIG. 12 shows the arrangement of several circuit boards twisted by 90° on both sides of a backplane by means of the plug connector in accordance with the invention.

### DETAILED DESCRIPTION OF THE PREFERRED EMBODIMENTS

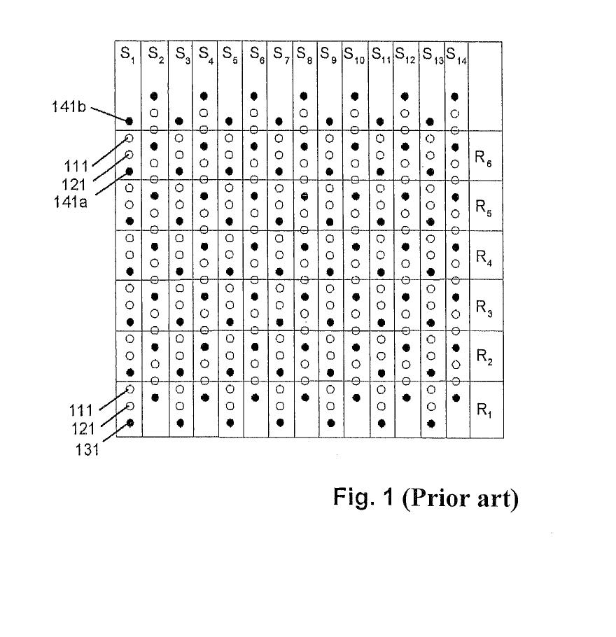

FIGS. 1 to 5 show a conventional plug connector as known from DE 10 2009 040 482 A1 for example. FIG. 1 shows the rear side of such a plug connector. The rear side of a plug connector shall be understood in the description below as such side on which the shielding contact elements and signal contact elements are arranged (circuit board side). The signal contact elements 111, 121 and the shielding contact elements 131 are arranged in the rows R₁ to R₆ and in the columns S₁ to S₁₄. One shielding contact element 131 respectively follows two signal contact elements 111, 121 within each column. Two signal contact elements 111, 121 which respectively follow each other within a column jointly form a differential pair. The columns are arranged in an offset manner with respect to each other, so that one respective differential pair is arranged between two shielding contact elements 131 within each row, wherein each signal contact element 111, 121 of each differential pair is respectively provided with the same distance to the two adjacent shielding contact elements 131. It is obvious that two such plug connectors cannot be arranged twisted by 90° with respect to each other on two opposite sides of a circuit board in such a way that corresponding signal contact elements 111, 121 can be connected to each other. Although the shielding contact elements 131 would come to lie on top of each other in an overlapping fashion in the case of a rotation of the two plug connectors by 90° with respect to each other, the establishment of contact between the signal contact elements 111, 121 would not be possible however.

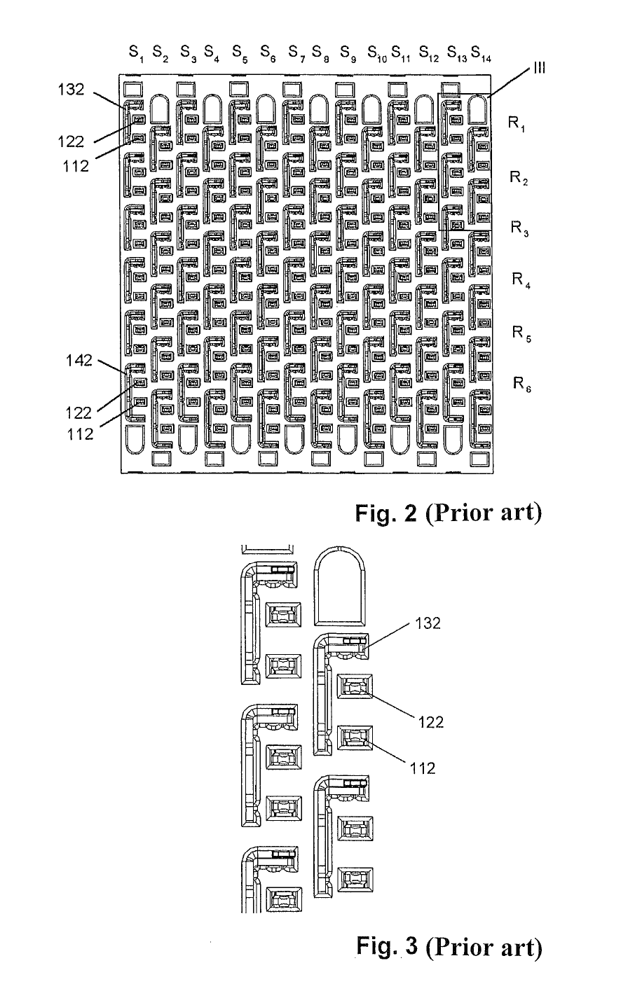

FIG. 2 shows the front side of the known plug connector. The front side of the plug connector shall be understood below as the side on which the blade elements and the shielding elements are arranged (plug side). The blade elements 112, 122 and the shielding elements 132 of the known plug connector are arranged in rows R₁ to R₆ and in columns S₁ to S₁₄. In each column, the two blade elements 112, 122 of a differential pair are surrounded on two sides by an L-shaped shielding element 132. A shielding element following said shielding element 132 shields the third side of the differential pair within each column. At the boundary to an adjacent column, shielding of the differential pair occurs by two shielding elements 132 of the adjacent column. This is achieved in such a way that the offset between the respectively adjacent columns, which were described in FIG. 1 for the signal contact elements 111, 121 and the shielding contact elements 1 of the 31, also continue on the front side of the plug connector for the blade elements 112, 122 and the shielding elements 132. At the end of each column, an L-shaped shielding element 132 is replaced by a C-shaped shielding contact element 142 in order to ensure shielding towards the end of the column. The C-shaped shielding element 142 comprises two shielding contact elements 142a, 142b. A detailed sectional view of the rows R₁ and R₂ in the columns S₁₃ and S₁₄ in FIG. 2 (marked there with reference numeral III) is shown in FIG. 3.

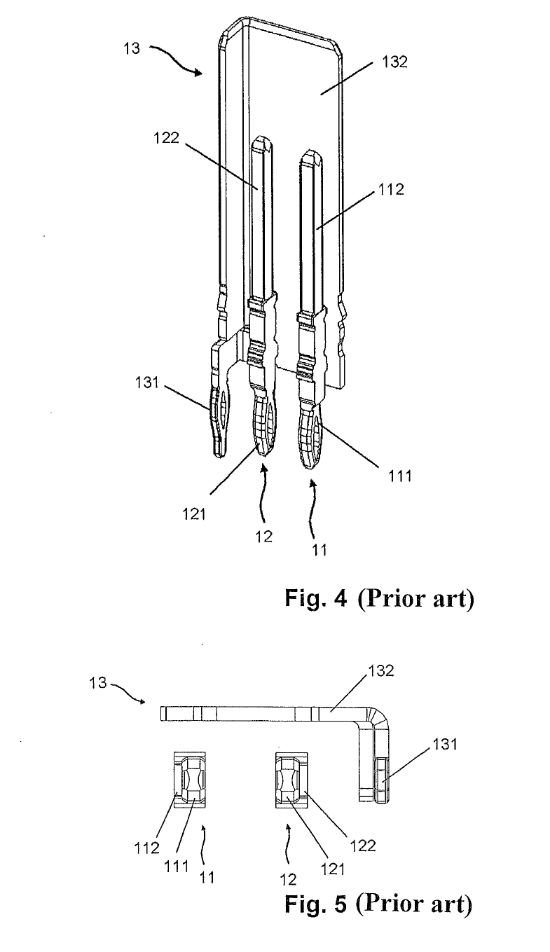

An isometric view of a differential pair of two signal contacts 11, 12 and its associated shielding contact 13 is shown in FIG. 4. A view of a differential pair and its associated shielding contact 13 is shown in FIG. 5 from below, i.e. from the direction of the signal contact elements 111, 121 and thus shielding contact element 131. A top view of a differential pair of two blade elements 112, 122 and the associated shielding element 132 is shown in FIG. 4. The illustration shows that the shielding element 132 converges into its shielding contact element 131 in the same column in which the blade elements 112, 122 are arranged.

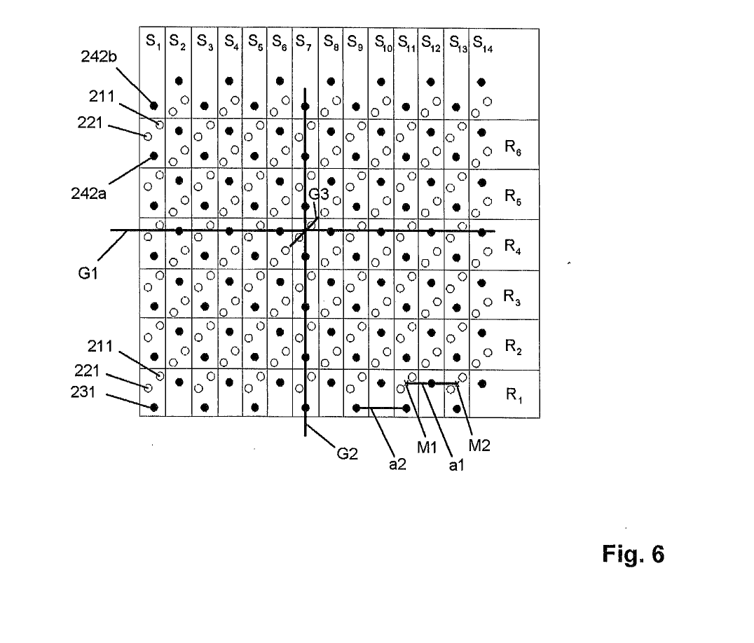

FIGS. 6 to 10 show an embodiment of a plug connector in accordance with the invention. FIG. 6 shows the rear side of the plug connector in accordance with the invention. All signal contact elements 211, 221 and all shielding contact elements 231 are arranged in rows R₁ to R₆ and in columns S₁ to S₁₄. All shielding contact elements 231 within a row lie on a common straight line G1. All shielding contact elements 231 within a column S lie on a common straight line G2. The signal contact elements 211, 221 of each differential pair respectively lie on a straight line G3, which forms an angle of 45° with the common straight line G1 of the shielding contact elements to 31 within the row and which also forms an angle of 45° with the common straight line G2 of the shielding contact elements 231 within the gap. This is shown in FIG. 6 by way of example for the column S₇ and the row R₄. The illustration shows that this arrangement of the signal contact elements 211, 221 and the shielding contact elements 231 has a quadruple rotation-reflection axis (S4 axis of symmetry) which stands perpendicularly to the common plane of the signal contact elements 211, 221 and shielding contact elements 231. This allows arranging two connectors in accordance with the invention on two opposite sides of a circuit board in a manner twisted 90° with respect to each other, wherein mutually corresponding signal contact elements 211, 221 of the two plug connectors respectively come to lie on top of each other and the shielding contact elements 231 of the two plug connectors also respectively come to lie on top of each other and contact can thus be established in a direct manner and especially without any additional circuit-board conductors, connecting lines and the like.

In each row and in each column a distance a1 between the centre point M1 of the two signal contact elements 211, 221 of a differential pair and the centre point M2 of the signal contact elements 211, 221 of an adjacent differential pair substantially correspond to the distance a2 between two adjacent shielding contact elements 231.

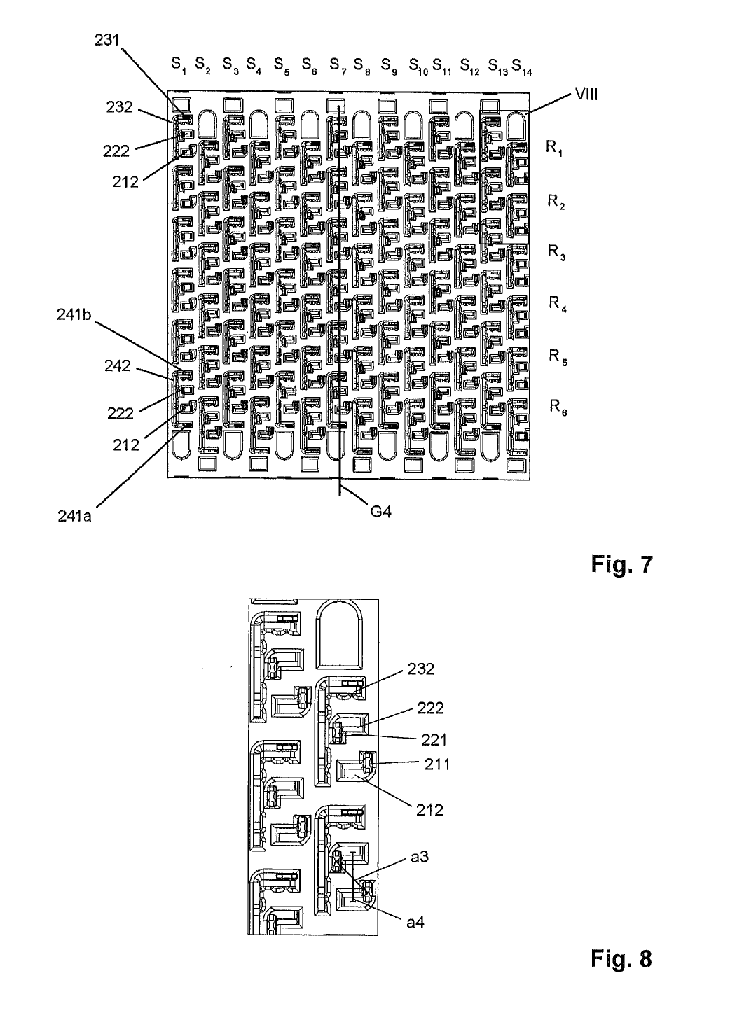

FIG. 7 shows a top view of the front side of the plug connector in accordance with the invention. A detailed sectional view of the rows R₁ and R₂ in the columns S₁₃ and S₁₄ in FIG. 7 (marked there with reference numeral VIII) is shown in FIG. 8. The blade elements 212, 222 and the shielding elements 232 of the known plug connector are also arranged in the rows R₁ to R₆ and in the columns S₁ to S₁₄. The shielding elements 231 are L-shaped, wherein an L-shaped shielding element 232 is replaced in each column by a C-shaped shielding contact element 242 at the end, which comprises two shielding contact elements 242a, 242b. In this way, shielding of the differential pairs consisting of two blade elements 212, 222 each is produced in the same manner as in the plug connector according to FIG. 2. All blade elements 212, 222 and all shielding contact elements 231 within a column lie on a common straight line G4. This is shown in FIG. 7 by way of example for the column S₇. The distance a3 between the two signal contact elements 211, 221 of each differential pair substantially corresponds to the distance a4 between the two blade elements 212, 222 of the differential pair.

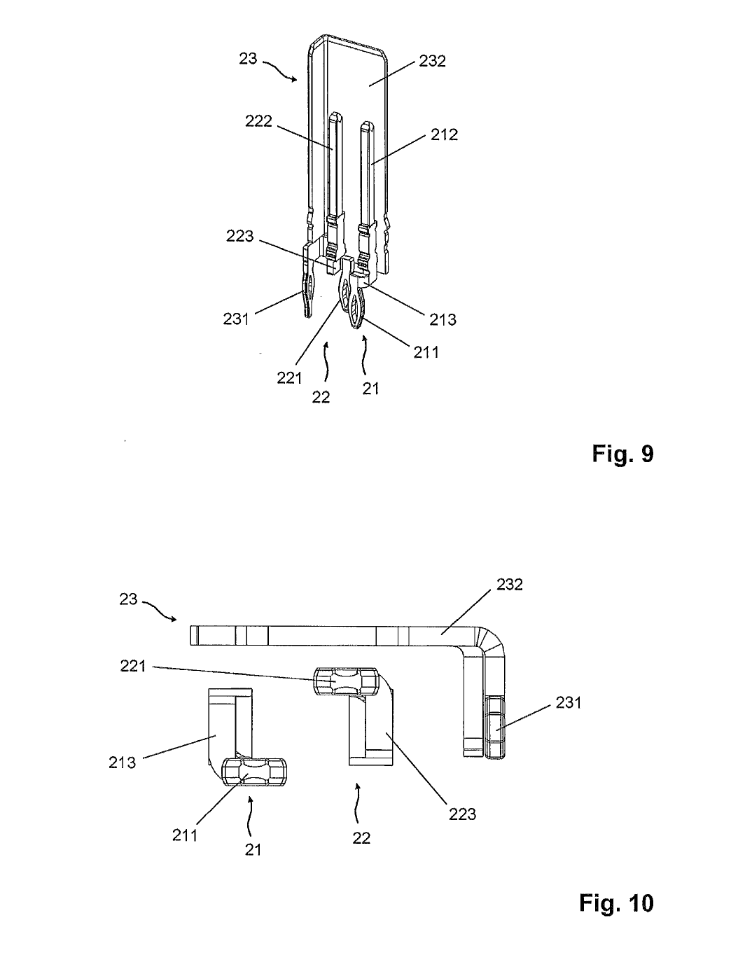

An isometric illustration of a differential pair consisting of two signal contacts 21, 22 and the associated shielding contact 13 is shown in FIG. 9. A view of a differential pair and its associated shielding contact 23 from below, i.e. from the direction of the signal contact elements 211, 221 and the shielding contact element 231, is shown in FIG. 10. The illustration shows that the blade element 212, 221 and the signal contact element 211, 221 are arranged in parallel with respect to each other in each signal contact 21, 22. They are connected to each other on a connecting element 213, 223. It is substantially rod-shaped and forms a right angle both with the blade element 212, 221 and also with the signal contact element 211, 221. This allows realising the arrangement of the blade elements 212, 221 and the shielding elements 232 on the front side of the plug connector which is twisted by 90° in accordance with the invention and the arrangement of the signal contact elements 211, 212 and the shielding contact elements 231 on the rear side of the plug connector.

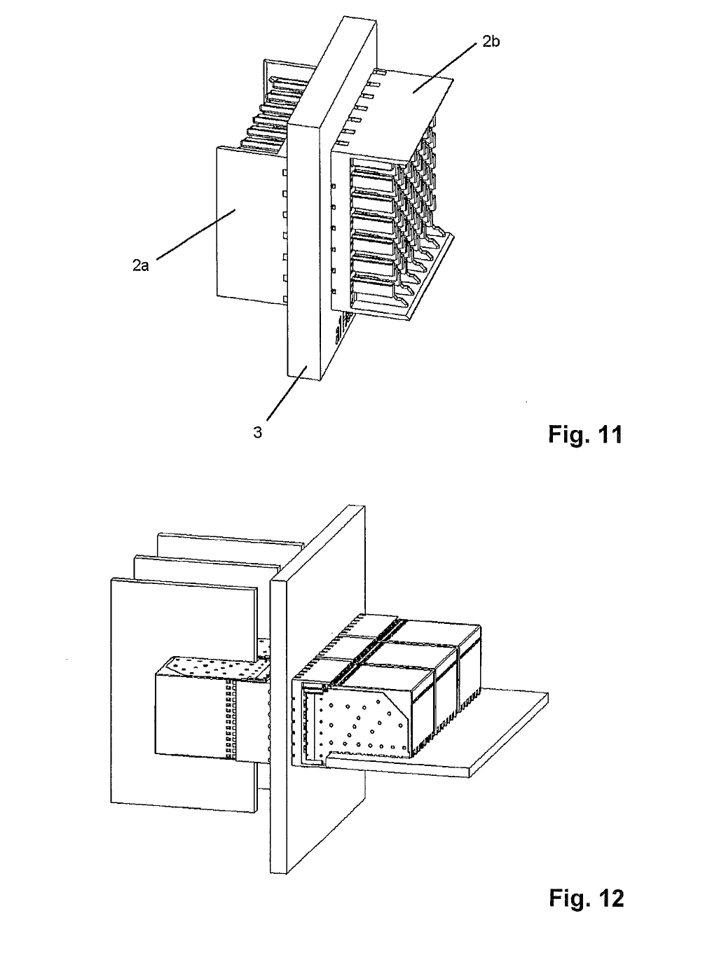

The fixing of two plug connectors 2a, 2b in accordance with the invention on a circuit board 3 is shown in FIG. 11. The signal contact elements 211, 221 and shielding contact elements 231 of the first plug connector 2a are arranged on one side of a circuit board 3 and the signal contact elements 211, 221 and shielding contact elements 231 of the second plug connector 2b are arranged on the other side of the circuit board 3. In this case, the respective signal contact elements 211, 221 of the first plug connector 2a are connected via the circuit board 3 to the corresponding signal contact elements 211, 221 of the second plug connector 2b. The first plug connector 2a is twisted at an angle of 90° in relation to the second plug connector 2b (cross-connect). The circuit board 3 can act in this manner as a backplane in order to connect further circuit boards to each other. It is therefore shown in FIG. 12 for example how a circuit board 4a can be connected via three connecting elements to three plug connectors in accordance with the invention on one side of a backplane 3, wherein three further plug connectors in accordance with the invention are situated on the opposite side of the backplane 3, which plug connectors respectively establish contact by a connecting element to a further printed circuit board 4b, 4c, 4d, so that the printed circuit board 4a can be connected to the printed circuit boards 4b, 4c, 4d which are twisted in relation to the circuit board 4a by 90°.

1. A plug connector (2a, 2b) with shielding, comprising signal contacts (21, 22) which are arranged in a contact pattern of differential pairs and form a contact group together with a shielding element (23) which surrounds them, wherein
each signal contact (21, 22) comprises a signal contact element (211, 221) and a blade element (212, 222);
each shielding contact (23) comprises a shielding element (232) and at least one shielding contact element (231, 241a, 241b);
the contact groups are arranged in rows (R₁ . . . R₆) and columns (S₁ . . . S₁₄);
all shielding contact elements (231, 241a, 241b) lie within a row (R₁ . . . R₆) on a common straight line (G1), and
the signal contact elements (211, 221) of each differential pair respectively lie on a straight line (G3) which forms an angle of 45° with the common straight line (G1) of the shielding contact elements (231, 241a, 241b) within the row (R₁ . . . R₆),
wherein in each row (R₁ . . . R₆) and in each column (S₁ . . . S₁₄), a distance (a1) between a centre point (M1) of the two signal contact elements (211, 221) of a differential pair and the centre point (M2) of the signal contact elements (211, 221) of an adjacent differential pair substantially correspond to the distance (a2) between two adjacent shielding contact elements (231, 241a, 241b).

2. The plug connector (2a, 2b) according to claim 1, wherein
all shielding contact elements (231, 241a, 241b) within a column (S₁ . . . S₁₄) lie on a common straight line (G2), and
the signal contact elements (211, 221) of each differential pair respectively lie on a straight line (G3) which forms an angle of 45° with the common straight line (G2) of the shielding contact elements (231, 241a, 241b) within the column (S₁ . . . S₁₄).

3. The plug connector (2a, 2b) according to claim 1, wherein all blade elements (111, 121) within a column (S₁ . . . S₁₄) lie on a common straight line (G4).

4. (canceled)

5. The plug connector (2a, 2b) according to claim 1, wherein a shielding element (242) is arranged in a C-shaped manner in each column (S₁ . . . S₁₄) and all further shielding elements (232) in said column (S₁ . . . S₁₄) are arranged in an L-shaped manner.

6. The plug connector (2a, 2b) according to claim 5, wherein each shielding contact (23) with L-shaped shielding element (232) comprises a shielding contact element (231) and each shielding contact with C-shaped shielding element (242) comprises two shielding contact elements (241a, 242b).

7. The plug connector (2a, 2b) according to claim 1, wherein the signal contact element (211, 221) and the blade element (212, 222) of each signal contacts (21, 22) are arranged in parallel with respect to each other and are connected to each other by a connecting element (213, 223).

8. The plug connector (2a, 2b) according to claim 1, wherein the distance (a3) between the two signal contact elements (211, 221) of each differential pair substantially corresponds to the distance (a4) between the two blade elements (212, 222) of the differential pair.

9. The arrangement comprising two plug connectors (2a, 2b) according to claim 1, wherein the signal contact elements (211, 221) and shielding contact elements (231, 241a, 241b) of the first connector (2a) are arranged on one side of the circuit board (3) and the signal contact elements (211, 221) and shielding contact elements (231, 241a, 241b) of the second connector (2b) are arranged on the other side of the circuit board (3), wherein the signal contact elements (211, 221) of the first plug connector (2a) are connected to the signal contact elements (211, 221) of the second plug connector (2b), and the first plug connector (2a) is twisted at an angle of 90° in relation to the second plug connector (2b).
